(19) United States
(12) Patent Application Publication
(10) Pub. No.: US 2018/0047073 A1
(43) Pub. Date: Feb. 15, 2018

(54) System and Method for Purchases Financed by Reverse Factoring on a Mobile Device

(71) Applicant: TARYAG WORK CAPTAL BS"D LTD, Petach Tikva (IL)

(72) Inventor: Simcha Neumark, Ramat Gan (IL)

(21) Appl. No.: 15/547,364

(22) PCT Filed: Jan. 27, 2016
(86) PCT No.: PCT/IL2016/050088

§ 371 Date: Jul. 28, 2017

Related U.S. Application Data
(60) Provisional application No. 62/109,119, filed on Jan. 29, 2015.

(51) Int. Cl. G06Q 30/04; G06Q 40/02

(52) U.S. Cl. CPC G06Q 30/04; G06Q 40/025

(57) ABSTRACT

Systems and methods are disclosed for a computerized and mobile reverse factoring payment platform. The systems and method include analyzing a plurality of payment parameters received from said buyer, loading said payment parameters and said invoice parameters into an array, defining a credit risk value based on analysis of a plurality of predefined credit risk parameters corresponding to said buyer and assigning a credit risk value based on analysis of a plurality of predefined credit risk parameters to said buyer; locating said payment parameters to determine credit risk value corresponding to said buyer, and retrieving said credit risk value from said array according to said predefined credit risk parameters corresponding to said payment parameters and said invoice parameters, and applying a discount factor value corresponding to said retrieved credit risk value; outputting said retrieved credit risk value and said discount factor value into said storage system; and presenting to said buyer and said supplier said retrieved credit risk value from said storage system according to said predefined credit risk parameters corresponding to said payment parameters and said invoice parameters and said discount factor value on a display screen.

### FIELD OF THE INVENTION

The present disclosure relates to system and method of a computerized and mobile reverse factoring payment platform, and more specifically to the creation of invoices where respective prices are determined by the underlying risk of a payee making a payment within established payment terms.

### BACKGROUND OF THE INVENTION

Typically, in the business to business payment world suppliers always want to receive payment for a purchase immediately. Businesses making that purchase always want longer payment terms such as ninety or one hundred and twenty days to pay for a purchase order. These two utility preferences have created tremendous inefficiencies in the B2B payment space. The financial industry tried to solve this market inefficiency in two separate verticals. Banks created the credit card for a purchaser extending him an immediate credit line. Many methods such as merchant cash advances, a traditional loan, and terms have existed to service the purchaser. The supplier was treated with credit card acceptance, credit insurance, and finally the option of factoring a receivable. These methods are sometimes bureaucratic and take a high toll on the profit margins of both suppliers and purchasers. The main reason these methods are still a costly solution to both buyer and seller is the lack of cooperation. There is no possibility of simultaneously sharing the cost associated of receiving payment immediately as a supplier and receive elongated payment terms as a buyer. Businesses around the world suffer with this inefficiency on a constant basis: the supplier is typically discounted at a high discount rate when selling invoices to a factor; the consumer is unable to get the terms he needs when making a purchase, and ends up resorting to a loan with very high interest rates.

Furthermore, when a supplier requests that a factor provide him with working capital relief, the business must sell an entire book of invoices without individual consideration of the risk of the payee behind each invoice. Subsequently the average discount rate on a book of invoices are far higher significantly impacting the supplier's operating margins, since there is no consideration in the underwriting process in the side of the factor on who will be making payment for that invoice.

Another inefficiency in current supply chain financing arises due to the fact that a factor always buys invoices reflecting transactions that already took place. This drastically impacts the discount factor of any given payee, since the factor is unable to effectively gauge whether or not that payee will be able to pay that invoice and assigns the discount rate solely based on the financial health of the factor.

Even though reverse factoring has been implemented since the late 1980's, it has failed to effectively provide a method for supply chain financing. In principal, reverse factoring gives the option of a buyer (typically a large corporation with great credit standing) pre-approving payment for an invoice. The supplier is then able to request that any given financial institution purchase that receivable taking into account the payee's credit standing, and not his own. Current methods of reverse factoring fail to address the fact that in most scenarios a buyer will not be a corporate-grade payee. Today, no bank will use a small and medium business as an “anchor” for a supply chain finance program, due to the large overhead costs associated with the transaction.

Until very recently, there was no possibility of underwriting a small and medium business in real-time. Due to the creation of e-invoicing, and the widespread use of cloud ERP systems by small and medium businesses, we are able to underwrite and understand in real-time the financial health of any small business.

In addition, reverse factoring requires a number of hours at best until the three parties are able to reach an agreement, and even the best systems today are unable to provide a real-time response in case a purchaser walks in to a store and tries to get financing for any random purchase order immediately.

However, today, with the widespread use of mobile phones, this inefficiency could be solved. At the end of 2014 however, recent studies by the Pew Center, and eMarketer show that smartphones users make up 63.8% of all mobile phone usage in the United States of America, and the prediction is that by the end of 2017, 80% of all mobile users will be using a mobile phone. Furthermore, another Pew study points to the fact that 28% of online workers say that a smartphone is indispensable in their way of doing business.

Furthermore, there is a bureaucratic and paper-intensive aspect of supply chain financing that makes any transaction difficult to be processed. This aspect has yet to be improved by current solutions offered. Buyers, sellers and their respective financial institutions are required to prepare, exchange, and process numerous commercial and financial documents associated with each transaction. High-volume buyers and sellers, in particular, are faced with overwhelming paperwork, expense, and administrative challenges.

Presently, the financing of commercial transactions is a rudimentary yet error-prone process. A buyer that wants to purchase widgets from a seller, for example, may initiate the transaction by preparing and submitting to the seller a purchase order containing the items or products desired, the quantity, and other relevant details, such as desired delivery date and location, for example. The buyer may also include financial documents, such as a letter of credit or other commercial documents, for example, which may be prepared by the buyer's bank to help speed up the order. Upon receiving the documents, the seller will prepare and deliver to the buyer a request for payment (or invoice), along with shipping documents detailing delivery date and location. The invoice typically includes a maturity date by which the buyer must make payment. Upon receiving the invoice, the buyer arranges for payment to be made on the date of maturity listed on the invoice, or on any other predetermined or agreed upon date.

Current systems and methods are available where a buyer may obtain financing, such as through a bank that will pay the invoice amount on or at maturity in exchange for interest from the buyer. In some cases, the bank may further leverage the transaction by offering the seller early or immediate payment in exchange for a discount. Though current processes for financing trade transactions seem simple and straightforward, they nonetheless suffer from several drawbacks. First, documents (e.g., invoices and discount proposals) may not be properly submitted or delivered in a timely fashion, or are not fully accessible by the parties, leading to confusion and delay in payment and/or financing. Further, even when documents are timely received and readily available to the parties, there exists no reliable and efficient way for a buyer to initiate financing, for a financial institution to automatically receive and process invoice documents and determine and present a plurality of discount proposals and options, or for a seller to receive, assess and negotiate the terms of the discount proposals and options and/or prepare and present counter-discount proposals. One problem with the financing in the typical trading relationship is costly.

Reducing supply chain barriers could increase global GDP and world trade much more than reducing all import tariffs, according to a new report released today by the World Economic Forum in collaboration with Bain & Company and the World Bank. Enabling Trade: Valuing Growth Opportunities finds that if all countries reduce supply chain barriers halfway to global best practice, global GDP could increase by 4.7% and world trade by 14.5%, far outweighing the benefits from the elimination of all import tariffs. In comparison, completely eliminating tariffs could increase global GDP by 0.7% and world trade by 10.1%. Even a less ambitious set of reforms that moves countries halfway to regional best practice could increase global GDP by 2.6% and world trade by 9.4%. Economic gains from reducing supply chain barriers are also more evenly distributed across countries than the gains associated with tariff elimination. Regions that stand to benefit in particular under these scenarios are sub-Saharan Africa and South East Asia. Such large increases in GDP would be associated with positive effects on unemployment, potentially adding millions of jobs to the global workforce. According to the report, lowering supply chain barriers is effective because it eliminates resource waste and reduces costs to trading firms and, by extension, lowers prices to consumers and businesses. Supply chain barriers can result from inefficient customs and administrative procedures, complex regulation and weaknesses in infrastructure services, among many others. The supply chain is the network of activities involved in producing and getting a product to consumers, and spans the manufacturing process as well as transport and distribution services. When one considers the total dollar value of goods shipped through third party providers, the value created by reducing the financing cost by even a few basis points is far greater than any cost savings possible from traditional transportation and warehousing targets.

None of the current technologies and prior art, taken alone or in combination, does not address nor provide a solution for a computerized and mobile reverse factoring payment platform for a small “anchor” client. Furthermore, there is a complete absence of a system that defines the price of a purchase to be paid in a future date based solely on the risk of repayment. More specifically referring to the creation of invoices capabilities, the known technologies in prior art do not refer to the same level of the system scalability to aggregate and generate respective prices. The current system and method completely determines the price charged by a sale based primarily on the underlying risk of a payee making a payment within established payment terms.

Therefore, there is a long felt and unmet need for a system and method that overcomes the problems associated with the prior art.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY

The present invention provides a computing device for automatically providing purchases financed by reverse factoring on a mobile device between at least one buyer, and at least one supplier that provides goods/services to said buyer outside of said system, each of which accesses said computing device system through a computer network interface, said computing device comprising a storage system and further comprising: (a) an analyzing module operable to analyze a plurality of payment parameters received from said buyer, said payment parameters comprising at least one payment price value and at least one payment maturity date value, and operable to analyze a plurality of invoice parameters received from said supplier, said invoice parameters comprising at least one invoice price value and at least one invoice maturity date value; (b) a loading module operable to load said payment parameters and said invoice parameters into an array, wherein said each value of said predefined payment parameters is an element of said array; (c) a ranking module operable to define a credit risk value based on analysis of a plurality of predefined credit risk parameters corresponding to said buyer and assign a credit risk value based on analysis of a plurality of predefined credit risk parameters to said buyer; (d) a processing module operable to locate said payment parameters to determine credit risk value corresponding to said buyer, and retrieve said credit risk value from said array according to said predefined credit risk parameters corresponding to said payment parameters and said invoice parameters, and operable apply discount factor value corresponding to said retrieved credit risk value; (e) an outputting module operable to output said retrieved credit risk value and said discount factor value into said storage system; (f) a displaying module operable to present to said buyer and said supplier said retrieved credit risk value from said storage system according to said predefined credit risk parameters corresponding to said payment parameters and said invoice parameters and said discount factor value on a display screen; (g) at least one processor that executes said analyzing module, said loading module, said ranking module, said processing module, said outputting module, and said displaying module.

It is another object of the current invention to disclose the device as described above, wherein said ranking module defines said credit risk value based on analysis of a plurality of predefined credit risk parameters corresponding to said buyer and assign a credit risk value based on analysis of a plurality of predefined credit risk parameters to said buyer in said array.

It is another object of the current invention to disclose the device as described above, wherein said plurality of predefined credit risk parameters comprises transactional and financial data of said buyer.

It is another object of the current invention to disclose the device as described above, wherein said invoice parameters comprise data retrieved from at least one invoice.

It is another object of the current invention to disclose the device as described above further comprising an intermediary module for generating reverse factoring transacting system corresponding to said retrieved credit risk value from said storage system according to said predefined credit risk parameters corresponding to said payment parameters and said invoice parameters and said discount factor value comprising a plurality of predefined schemes for a payment period.

It is another object of the current invention to disclose the device as described above further comprising a payment module for arrangement of capital transfer between said buyer and/or said and/or said supplier corresponding to said generated reverse factoring transacting system.

The present invention provides a computer-implemented method being executed by a processor of a computing device for automatically providing purchases financed by reverse factoring on a mobile device between at least one buyer, and at least one supplier that provides goods/services to said buyer outside of said system, each of which accesses said computing device system through a computer network interface, said method comprising: (a) analyzing a plurality of payment parameters received from said buyer, said payment parameters comprising at least one payment price value and at least one payment maturity date value, and analyzing a plurality of invoice parameters received from said supplier, said invoice parameters comprising at least one invoice price value and at least one invoice maturity date value; (b) loading said payment parameters and said invoice parameters into an array, wherein said each value of said predefined payment parameters is an element of said array; (c) defining a credit risk value based on analysis of a plurality of predefined credit risk parameters corresponding to said buyer and assigning a credit risk value based on analysis of a plurality of predefined credit risk parameters to said buyer; (d) locating said payment parameters to determine credit risk value corresponding to said buyer, and retrieving said credit risk value from said array according to said predefined credit risk parameters corresponding to said payment parameters and said invoice parameters, and applying a discount factor value corresponding to said retrieved credit risk value; (e) outputting said retrieved credit risk value and said discount factor value into said storage system; and (f) presenting to said buyer and said supplier said retrieved credit risk value from said storage system according to said predefined credit risk parameters corresponding to said payment parameters and said invoice parameters and said discount factor value on a display screen.

It is another object of the current invention to disclose the method as described above, wherein said step of defining said credit risk value based on analysis of a plurality of predefined credit risk parameters corresponding to said buyer and assign a credit risk value based on analysis of a plurality of predefined credit risk parameters to said buyer is performed in said array.

It is another object of the current invention to disclose the method as described above, wherein said plurality of predefined credit risk parameters comprises transactional and financial data of said buyer.

It is another object of the current invention to disclose the method as described above, wherein said invoice parameters comprise data retrieved from at least one invoice.

It is another object of the current invention to disclose the method as described above further comprising a step of generating reverse factoring transacting system corresponding to said retrieved credit risk value from said storage system according to said predefined credit risk parameters corresponding to said payment parameters and said invoice parameters and said discount factor value comprising a plurality of predefined schemes for a payment period.

It is another object of the current invention to disclose the method as described above further comprising a step of arranging capital transfer between said buyer and/or said and/or said supplier corresponding to said generated reverse factoring transacting system.

The present invention provides a non-transitory computer-readable medium having stored thereon instructions that, when executed by a computerized device, cause said computerized device to execute a computer-implemented method comprising: (a) analyzing a plurality of payment parameters received from said buyer, said payment parameters comprising at least one payment price value and at least one payment maturity date value, and analyzing a plurality of invoice parameters received from said supplier, said invoice parameters comprising at least one invoice price value and at least one invoice maturity date value; (b) loading said payment parameters and said invoice parameters into an array, wherein said each value of said predefined payment parameters is an element of said array; (c) defining a credit risk value based on analysis of a plurality of predefined credit risk parameters corresponding to said buyer and assigning a credit risk value based on analysis of a plurality of predefined credit risk parameters to said buyer; (d) locating said payment parameters to determine credit risk value corresponding to said buyer, and retrieving said credit risk value from said array according to said predefined credit risk parameters corresponding to said payment parameters and said invoice parameters, and applying a discount factor value corresponding to said retrieved credit risk value; (e) outputting said retrieved credit risk value and said discount factor value into said storage system; and (f) presenting to said buyer and said supplier said retrieved credit risk value from said storage system according to said predefined credit risk parameters corresponding to said payment parameters and said invoice parameters and said discount factor value on a display screen.

It is another object of the current invention to disclose the non-transitory computer-readable medium as described above, wherein said step of defining said credit risk value based on analysis of a plurality of predefined credit risk parameters corresponding to said buyer and assign a credit risk value based on analysis of a plurality of predefined credit risk parameters to said buyer is performed in said array.

It is another object of the current invention to disclose the non-transitory computer-readable medium as described above, wherein said plurality of predefined credit risk parameters comprises transactional and financial data of said buyer.

It is another object of the current invention to disclose the non-transitory computer-readable medium as described above, wherein said invoice parameters comprise data retrieved from at least one invoice.

It is another object of the current invention to disclose the non-transitory computer-readable medium as described above, wherein the non-transitory computer-readable medium causes said computerized device to execute a computer-implemented method further comprising a step of generating reverse factoring transacting system corresponding to said retrieved credit risk value from said storage system according to said predefined credit risk parameters corresponding to said payment parameters and said invoice parameters and said discount factor value comprising a plurality of predefined schemes for a payment period.

It is another object of the current invention to disclose the non-transitory computer-readable medium as described above, wherein the non-transitory computer-readable medium causes said computerized device to execute a computer-implemented method further comprising a step of arranging capital transfer between said buyer and/or said and/or said supplier corresponding to said generated reverse factoring transacting system.

### BRIEF DESCRIPTION OF THE FIGURES

In the following detailed description of the preferred embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1 is a block diagram of one embodiment of a system of the present invention;

FIG. 2 is a schematic flow diagram of one embodiment illustrating a flow chart of a method for the present invention;

FIG. 3 is a high-level overview of an exemplary process for a purchases financed by reverse factoring on a mobile device;

FIG. 4, FIG. 5, FIG. 6, FIG. 7, and FIG. 8 are an illustration of the embodiment of a screen shot of the user interface for both the buyer and the supplier as users of the platform.

FIG. 9 graphically illustrates, according to another preferred embodiment of the present invention, an example of computerized environment for implementing the invention.

### DETAILED DESCRIPTION OF THE EMBODIMENTS

The following description is provided, along all chapters of the present invention, so as to enable any person to make use of said invention and sets forth the best modes contemplated by the inventor of carrying out this invention. As is customary, it will be understood that no limitation of the scope of the invention is thereby intended. In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

This invention recites or refers to a computing device for automatically providing purchases financed by reverse factoring on a mobile device between at least one buyer, and at least one supplier that provides goods/services to said buyer outside of said system, each of which accesses said computing device system through a computer network interface, said computing device comprising a storage system and further comprising: (a) an analyzing module operable to analyze a plurality of payment parameters received from said buyer, said payment parameters comprising at least one payment price value and at least one payment maturity date value, and operable to analyze a plurality of invoice parameters received from said supplier, said invoice parameters comprising at least one invoice price value and at least one invoice maturity date value; (b) a loading module operable to load said payment parameters and said invoice parameters into an array, wherein said each value of said predefined payment parameters is an element of said array; (c) a ranking module operable to define a credit risk value based on analysis of a plurality of predefined credit risk parameters corresponding to said buyer and assign a credit risk value based on analysis of a plurality of predefined credit risk parameters to said buyer; (d) a processing module operable to locate said payment parameters to determine credit risk value corresponding to said buyer, and retrieve said credit risk value from said array according to said predefined credit risk parameters corresponding to said payment parameters and said invoice parameters, and operable apply discount factor value corresponding to said retrieved credit risk value; (e) an outputting module operable to output said retrieved credit risk value and said discount factor value into said storage system; (f) a displaying module operable to present to said buyer and said supplier said retrieved credit risk value from said storage system according to said predefined credit risk parameters corresponding to said payment parameters and said invoice parameters and said discount factor value on a display screen; (g) at least one processor that executes said analyzing module, said loading module, said ranking module, said processing module, said outputting module, and said displaying module.

The invention further recites or refers to a computing device, wherein said ranking module defines said credit risk value based on analysis of a plurality of predefined credit risk parameters corresponding to said buyer and assign a credit risk value based on analysis of a plurality of predefined credit risk parameters to said buyer in said array.

The invention further recites or refers to a computing device, wherein said plurality of predefined credit risk parameters comprises transactional and financial data of said buyer.

The invention further recites or refers to a computing device, wherein said invoice parameters comprise data retrieved from at least one invoice.

The invention further recites or refers to a computing device further comprising an intermediary module for generating reverse factoring transacting system corresponding to said retrieved credit risk value from said storage system according to said predefined credit risk parameters corresponding to said payment parameters and said invoice parameters and said discount factor value comprising a plurality of predefined schemes for a payment period.

The invention further recites or refers to a computing device further comprising a payment module for arrangement of capital transfer between said buyer and/or said and/or said supplier corresponding to said generated reverse factoring transacting system.

The invention further recites a computer-implemented method being executed by a processor of a computing device for automatically providing purchases financed by reverse factoring on a mobile device between at least one buyer, and at least one supplier that provides goods/services to said buyer outside of said system, each of which accesses said computing device system through a computer network interface, said method comprising: (a) analyzing a plurality of payment parameters received from said buyer, said payment parameters comprising at least one payment price value and at least one payment maturity date value, and analyzing a plurality of invoice parameters received from said supplier, said invoice parameters comprising at least one invoice price value and at least one invoice maturity date value; (b) loading said payment parameters and said invoice parameters into an array, wherein said each value of said predefined payment parameters is an element of said array; (c) defining a credit risk value based on analysis of a plurality of predefined credit risk parameters corresponding to said buyer and assigning a credit risk value based on analysis of a plurality of predefined credit risk parameters to said buyer; (d) locating said payment parameters to determine credit risk value corresponding to said buyer, and retrieving said credit risk value from said array according to said predefined credit risk parameters corresponding to said payment parameters and said invoice parameters, and applying a discount factor value corresponding to said retrieved credit risk value; (e) outputting said retrieved credit risk value and said discount factor value into said storage system; and (f) presenting to said buyer and said supplier said retrieved credit risk value from said storage system according to said predefined credit risk parameters corresponding to said payment parameters and said invoice parameters and said discount factor value on a display screen.

The invention further recites a computer-implemented method being executed by a processor of a computing device for automatically providing purchases financed by reverse factoring on a mobile device between at least one buyer, and at least one supplier that provides goods/services to said buyer outside of said system, each of which accesses said computing device system through a computer network interface, wherein said step of defining said credit risk value based on analysis of a plurality of predefined credit risk parameters corresponding to said buyer and assign a credit risk value based on analysis of a plurality of predefined credit risk parameters to said buyer is performed in said array.

The invention further recites a computer-implemented method being executed by a processor of a computing device for automatically providing purchases financed by reverse factoring on a mobile device between at least one buyer, and at least one supplier that provides goods/services to said buyer outside of said system, each of which accesses said computing device system through a computer network interface, said plurality of predefined credit risk parameters comprises transactional and financial data of said buyer.

The invention further recites a computer-implemented method being executed by a processor of a computing device for automatically providing purchases financed by reverse factoring on a mobile device between at least one buyer, and at least one supplier that provides goods/services to said buyer outside of said system, each of which accesses said computing device system through a computer network interface, wherein said invoice parameters comprise data retrieved from at least one invoice.

The invention further recites a computer-implemented method being executed by a processor of a computing device for automatically providing purchases financed by reverse factoring on a mobile device between at least one buyer, and at least one supplier that provides goods/services to said buyer outside of said system, each of which accesses said computing device system through a computer network interface, further comprising a step of generating reverse factoring transacting system corresponding to said retrieved credit risk value from said storage system according to said predefined credit risk parameters corresponding to said payment parameters and said invoice parameters and said discount factor value comprising a plurality of predefined schemes for a payment period.

The invention further recites a computer-implemented method being executed by a processor of a computing device for automatically providing purchases financed by reverse factoring on a mobile device between at least one buyer, and at least one supplier that provides goods/services to said buyer outside of said system, each of which accesses said computing device system through a computer network interface, further comprising a step of arranging capital transfer between said buyer and/or said and/or said supplier corresponding to said generated reverse factoring transacting system.

The invention further recites a non-transitory computer-readable medium having stored thereon instructions that, when executed by a computerized device, cause said computerized device to execute a computer-implemented method comprising: (a) analyzing a plurality of payment parameters received from said buyer, said payment parameters comprising at least one payment price value and at least one payment maturity date value, and analyzing a plurality of invoice parameters received from said supplier, said invoice parameters comprising at least one invoice price value and at least one invoice maturity date value; (b) loading said payment parameters and said invoice parameters into an array, wherein said each value of said predefined payment parameters is an element of said array; (c) defining a credit risk value based on analysis of a plurality of predefined credit risk parameters corresponding to said buyer and assigning a credit risk value based on analysis of a plurality of predefined credit risk parameters to said buyer; (d) locating said payment parameters to determine credit risk value corresponding to said buyer, and retrieving said credit risk value from said array according to said predefined credit risk parameters corresponding to said payment parameters and said invoice parameters, and applying a discount factor value corresponding to said retrieved credit risk value; (e) outputting said retrieved credit risk value and said discount factor value into said storage system; and (f) presenting to said buyer and said supplier said retrieved credit risk value from said storage system according to said predefined credit risk parameters corresponding to said payment parameters and said invoice parameters and said discount factor value on a display screen.

The invention further recites a non-transitory computer-readable medium having stored thereon instructions that, when executed by a computerized device, cause said computerized device to execute a computer-implemented method, wherein said step of defining said credit risk value based on analysis of a plurality of predefined credit risk parameters corresponding to said buyer and assign a credit risk value based on analysis of a plurality of predefined credit risk parameters to said buyer is performed in said array.

The invention further recites a non-transitory computer-readable medium having stored thereon instructions that, when executed by a computerized device, cause said computerized device to execute a computer-implemented method, wherein said plurality of predefined credit risk parameters comprises transactional and financial data of said buyer.

The invention further recites a non-transitory computer-readable medium having stored thereon instructions that, when executed by a computerized device, cause said computerized device to execute a computer-implemented method, wherein said invoice parameters comprise data retrieved from at least one invoice.

The invention further recites a non-transitory computer-readable medium having stored thereon instructions that, when executed by a computerized device, cause said computerized device to execute a computer-implemented method, wherein the non-transitory computer-readable medium causes said computerized device to execute a computer-implemented method further comprising a step of generating reverse factoring transacting system corresponding to said retrieved credit risk value from said storage system according to said predefined credit risk parameters corresponding to said payment parameters and said invoice parameters and said discount factor value comprising a plurality of predefined schemes for a payment period.

The invention further recites a non-transitory computer-readable medium having stored thereon instructions that, when executed by a computerized device, cause said computerized device to execute a computer-implemented method, wherein the non-transitory computer-readable medium causes said computerized device to execute a computer-implemented method further comprising a step of arranging capital transfer between said buyer and/or said and/or said supplier corresponding to said generated reverse factoring transacting system.

The term “mobile device” interchangeably refers, but not limited to such as a mobile phone, laptop, tablet, cellular communicating device, digital camera (still and/or video), PDA, computer server, video camera, television, electronic visual dictionary, communication device, personal computer, and etc. The present invention means and methods are performed in a standalone electronic device comprising at least one screen. Additionally or alternatively, at least a portion of such as processing, memory accessible, databases, includes a cloud-based platform, and/or web-based platform. In some embodiments, the software components and/or image databases provided, are stored in a local memory module and/or stored in a remote server.

The term “CRM” computer readable medium, interchangeably refers hereinafter to any memory that can be accessed and interfaced with by a machine (e.g. computer) including, but not limited to, high-speed random access memory and may also include non-volatile memory, such as one or more magnetic disk storage devices, flash memory devices, or other non-volatile solid-state memory devices, a direct-access data storage media such as hard disks, CD-RWs and DVD-RW can also be used to store software components and/or image databases.

The term “display screen” interchangeably refers hereinafter to any touch-sensitive surface, known in the art, sensor or set of sensors that accepts input from the user based on haptic and/or tactile contact. The touch screen, along with any associated modules and/or sets of instructions in memory) detect contact, movement, detachment from contact on the touch screen and convert the detected contact into interaction with user-interface objects (e.g., one or more soft keys, icons, images, texts) that are displayed on the touch screen. In an embodiment, the user utilizes at least one finger to form a contact point detected by the touch screen. The user can navigate between the graphical outputs presented on the screen, and interact with presented digital navigation. Additionally or alternatively, the present application can be connected to a user interface detecting input from a keyboard, a button, a click wheel, a touchpad, a roller, a computer mouse, a motion detector, sound detector, speech detector, joystick, and etc., for activating or deactivating particular functions. A user can navigate among and interact with one or more graphical user interface objects that represent at least visual navigation content, displayed on screen. Preferably, the user navigates and interacts with the content/user interface objects by means of a touch screen. In some embodiments the interaction is by means such as computer mouse, motion sensor, keyboard, voice activation, joystick, electronic pad and pen, touch sensitive pad, a designated set of buttons, soft keys, and the like.

The term “storage” refers hereinafter to any collection, set, assortment, cluster, selection and/or combination of content stored digitally.

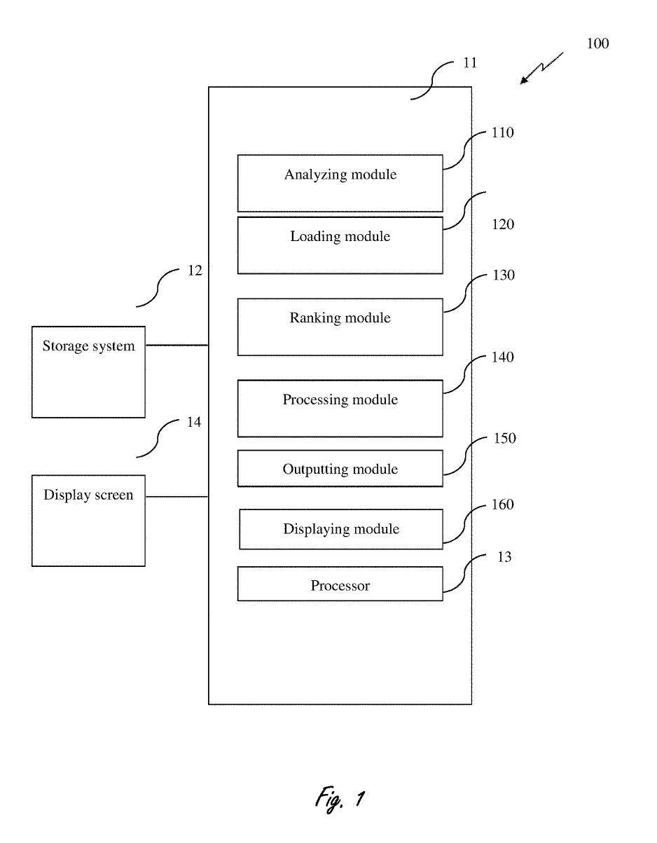

Reference is now made to FIG. 1 is a block diagram of one embodiment of a system for automatically providing purchases financed by reverse factoring on a mobile device between at least one buyer, and at least one supplier that provides goods/services to said buyer outside of said system, each of which accesses said computing device system through a computer network interface 100, said computing device 11 comprising a storage system 12 and further comprising: an analyzing module operable to analyze a plurality of payment parameters received from said buyer, said payment parameters comprising at least one payment price value and at least one payment maturity date value, and operable to analyze a plurality of invoice parameters received from said supplier, said invoice parameters comprising at least one invoice price value and at least one invoice maturity date value 110; a loading module operable to load said payment parameters and said invoice parameters into an array, wherein said each value of said predefined payment parameters is an element of said array 120; a ranking module operable to define a credit risk value based on analysis of a plurality of predefined credit risk parameters corresponding to said buyer and assign a credit risk value based on analysis of a plurality of predefined credit risk parameters to said buyer 130; a processing module operable to locate said payment parameters to determine credit risk value corresponding to said buyer, and retrieve said credit risk value from said array according to said predefined credit risk parameters corresponding to said payment parameters and said invoice parameters, and operable apply discount factor value corresponding to said retrieved credit risk value 140; an outputting module operable to output said retrieved credit risk value and said discount factor value into said storage system 150; a displaying module operable to present to said buyer and said supplier said retrieved credit risk value from said storage system according to said predefined credit risk parameters corresponding to said payment parameters and said invoice parameters and said discount factor value on a display screen 14 160; at least one processor that executes said analyzing module, said loading module, said ranking module, said processing module, said outputting module, and said displaying module 13.

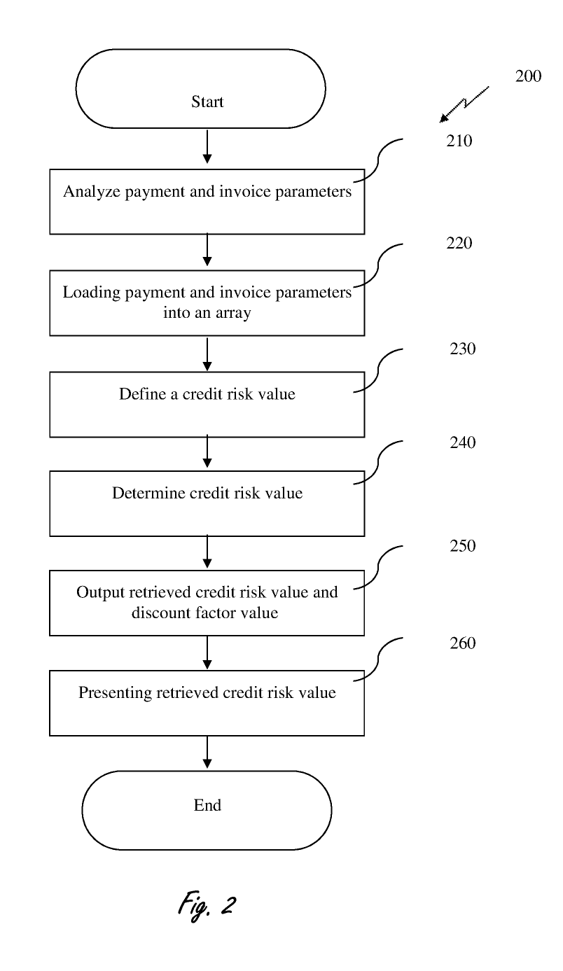

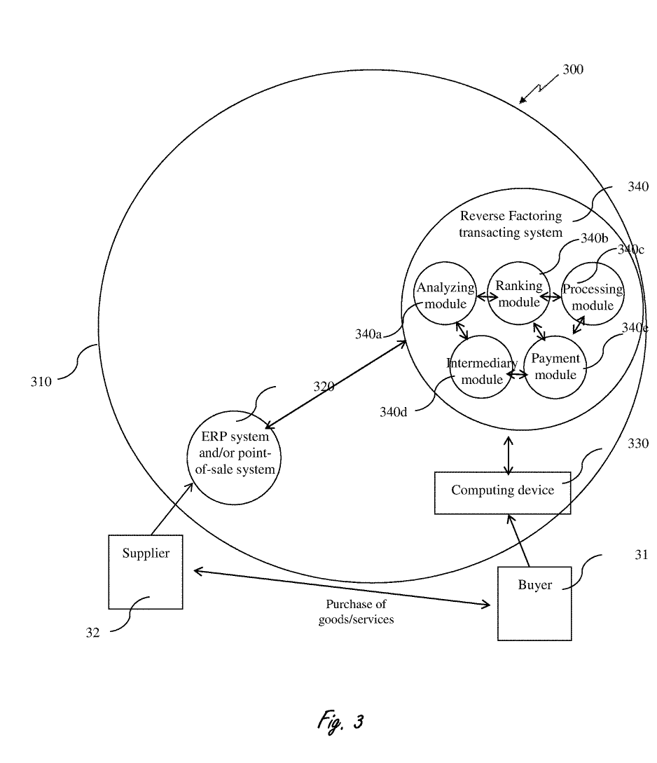

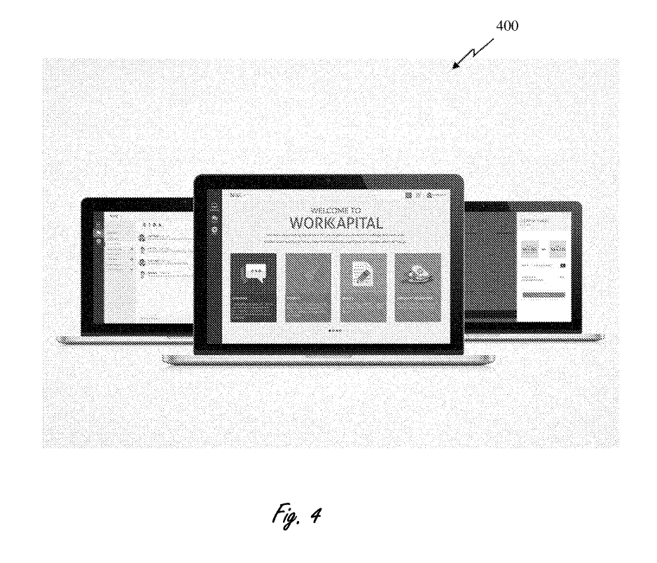

Reference is now made to FIG. 2 schematically illustrating a flow chart of a method for the present invention 200. A user launches a mobile application comprising a system for automatically providing reverse factoring transacting system between at least one buyer, and at least one supplier that provides goods/services to said buyer outside of said system, each of which accesses said computing device system through a computer network interface 100. A processor of a computing device for automatically providing purchases financed by reverse factoring on a mobile device using mobile device executes steps comprising of analyzing a plurality of payment parameters received from said buyer, said payment parameters comprising at least one payment price value and at least one payment maturity date value, and analyzing a plurality of invoice parameters received from said supplier, said invoice parameters comprising at least one invoice price value and at least one invoice maturity date value 210; loading said payment parameters and said invoice parameters into an array, wherein said each value of said predefined payment parameters is an element of said array 220; defining a credit risk value based on analysis of a plurality of predefined credit risk parameters corresponding to said buyer and assigning a credit risk value based on analysis of a plurality of predefined credit risk parameters to said buyer 230; locating said payment parameters to determine credit risk value corresponding to said buyer, and retrieving said credit risk value from said array according to said predefined credit risk parameters corresponding to said payment parameters and said invoice parameters, and applying a discount factor value corresponding to said retrieved credit risk value 240; outputting said retrieved credit risk value and said discount factor value into said storage system 250; and presenting to said buyer and said supplier said retrieved credit risk value from said storage system according to said predefined credit risk parameters corresponding to said payment parameters and said invoice parameters and said discount factor value on a display screen 260.

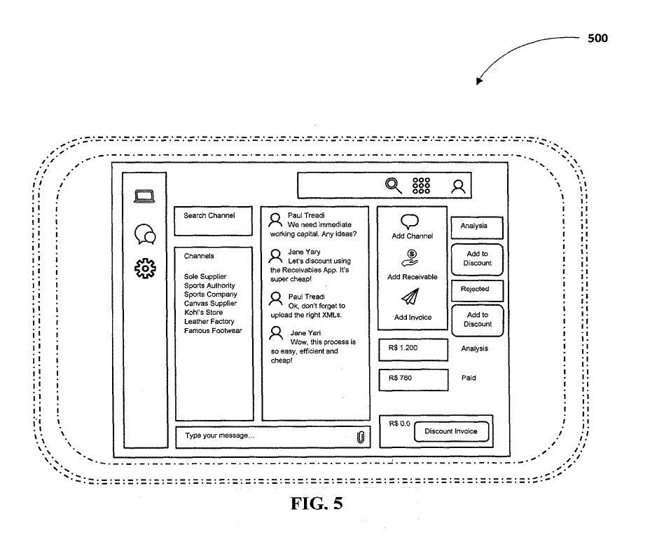

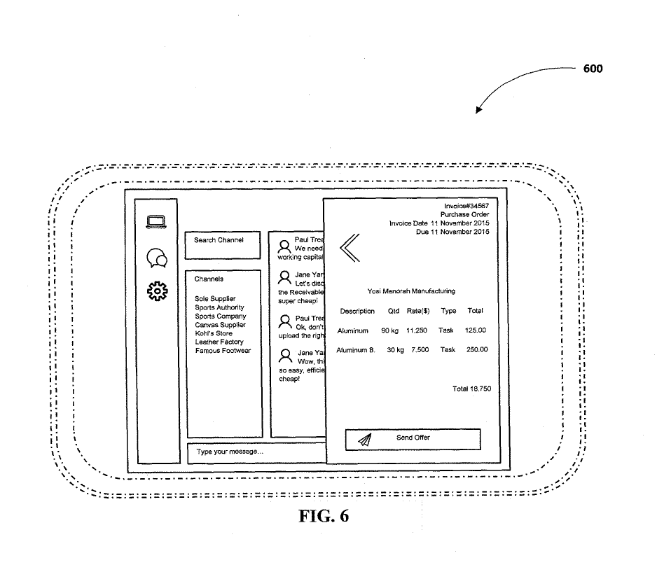

Reference is now made to FIG. 3, a high-level overview of an exemplary process for a purchases financed by reverse factoring on a mobile device between 300 of the present invention comprising steps of a buyer 31 attempting to purchase goods/services at a store 310 (online store or physical location) from a supplier 32; after said buyer chooses an item to be purchased, he/she requests a price quote, stating the transactional terms comprising at least one payment price value and at least one payment maturity date value; said supplier provides a price quote for an item stating an immediate terms of payment as a standard practice among good/services supplying businesses, payment which said buyer is unable to transfer on immediate terms. Said scenario qualifies an ordinary mode of making business between buyers and suppliers wherein many transactions are unable to take place due to the described above inefficiency and inability to define credit risk value including negotiation terms based on payment and invoice parameters; said buyer activates a reverse factoring transacting system 340 via his/her mobile device 330, accepting the terms of full access to perform analysis of a plurality of payment parameters received from said buyer 340a, said payment parameters comprising at least one payment price value and at least one payment maturity date value, and operable to analyze a plurality of invoice parameters received from said supplier, said invoice parameters comprising at least one invoice price value and at least one invoice maturity date value, predefined credit risk parameters comprising transactional and financial data of said buyer; said buyer is prompt with a digital calendar option chooses to accept transacting system corresponding to said retrieved credit risk value from said storage system according to said predefined credit risk parameters corresponding to said payment parameters and said invoice parameters and said discount factor value comprising a plurality of predefined schemes for a payment period. The computing device 330 activates ranking module operable to define a credit risk value based on analysis of a plurality of predefined credit risk parameters corresponding to said buyer and assign a credit risk value based on analysis of a plurality of predefined credit risk parameters to said buyer 340b. Said process doesn't necessarily take place only when preceded by a transaction that cannot take place between a buyer and a supplier due to aforementioned inefficiency wherein a buyer only desires to pay at a later date and a supplier demands payment immediately. The computing device activates analysis of a plurality of invoice parameters received from said supplier, based on an invoice uploaded via supplier's ERP (Enterprise Resource Planning) system and/or his/her point-of-sale system 320, said invoice parameters comprising at least one invoice price value and at least one invoice maturity date value 340a. The computing device activates processing model to locate said payment parameters to determine credit risk value corresponding to said buyer, and retrieving said credit risk value from said array according to said predefined credit risk parameters corresponding to said payment parameters and said invoice parameters, and applying a discount factor value corresponding to said retrieved credit risk value 340c. The computing device then activates an intermediary module for generating reverse factoring transacting system corresponding to said retrieved credit risk value from said storage system according to said predefined credit risk parameters corresponding to said payment parameters and said invoice parameters and said discount factor value comprising a plurality of predefined schemes for a payment period 340d. Lastly, the computing device activates a payment module for arrangement of capital transfer between said buyer and/or said and/or said supplier corresponding to said generated reverse factoring transacting system 340e, while the system allows reducing the cost of financing the relationships embedded in supply chains in a user-friendly and time-efficient manner responsive to a parties' needs through the integrated connection with the point of sale system and/or the ERP and/or for that matter any other method in which an invoice is generated.

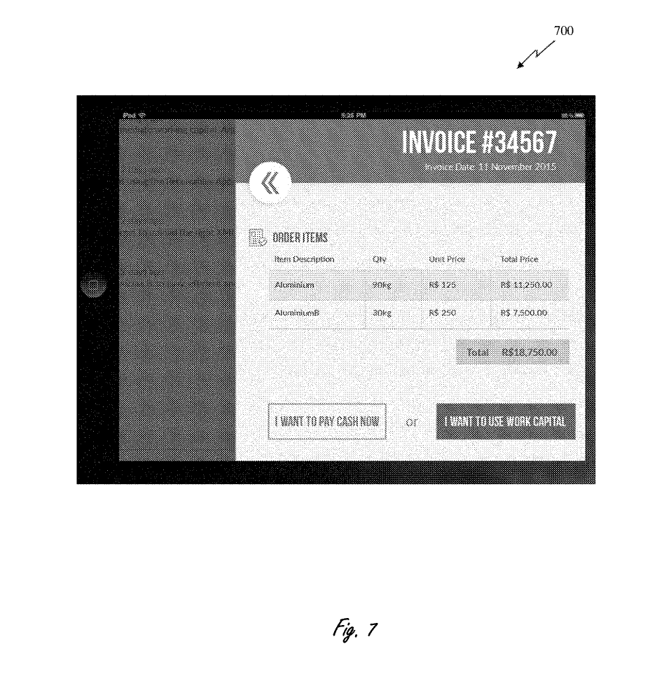

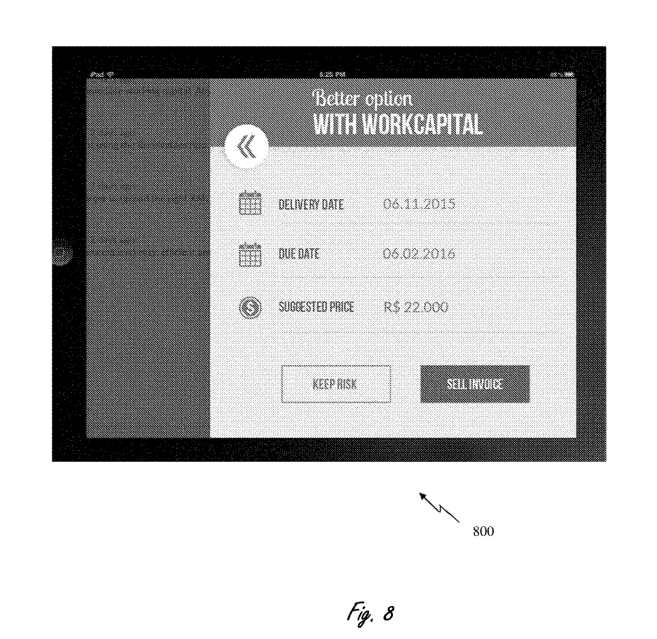

Reference is now made to FIG. 4, FIG. 5, FIG. 6, FIG. 7, FIG. 8 illustrating embodiments of a screen shot of the user interface 400, 500, 600, 700, and 800 accordingly.

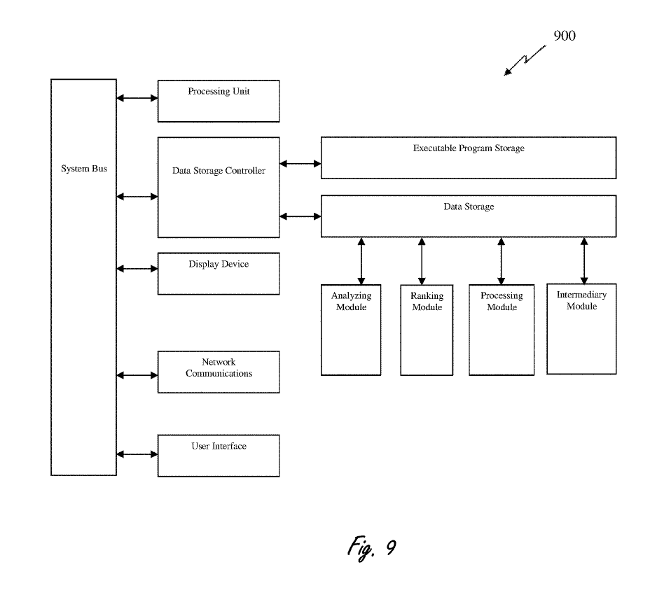

Reference is made now to FIG. 9 which graphically illustrates, according to another preferred embodiment of the present invention, an example of computerized system for implementing the invention 900. The systems and methods described herein can be implemented in software or hardware or any combination thereof. The systems and methods described herein can be implemented using one or more computing devices which may or may not be physically or logically separate from each other. Additionally, various aspects of the methods described herein may be combined or merged into other functions.

In some embodiments, the illustrated system elements could be combined into a single hardware device or separated into multiple hardware devices. If multiple hardware devices are used, the hardware devices could be physically located proximate to or remotely from each other.

The methods can be implemented in a computer program product accessible from a computer-usable or computer-readable storage medium that provides program code for use by or in connection with a computer or any instruction execution system. A computer-usable or computer-readable storage medium can be any apparatus that can contain or store the program for use by or in connection with the computer or instruction execution system, apparatus, or device.

A data processing system suitable for storing and/or executing the corresponding program code can include at least one processor coupled directly or indirectly to computerized data storage devices such as memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer with a display device, such as an LCD (liquid crystal display), or another type of monitor for displaying information to the user, and a keyboard and an input device, such as a mouse or trackball by which the user can provide input to the computer. A computer program can be a set of instructions that can be used, directly or indirectly, in a computer. The systems and methods described herein can be implemented using programming languages such as Flash™, JAVA™, C++, C, C#, Visual Basic™ JavaScript™, PHP, XML, HTML, etc., or a combination of programming languages, including compiled or interpreted languages, and can be deployed in any form, including as a stand-alone program or as a module, component, subroutine, or other unit suitable for use in a computing environment. The software can include, but is not limited to, firmware, resident software, microcode, etc. Protocols such as SOAP/HTTP may be used in implementing interfaces between programming modules. The components and functionality described herein may be implemented on any desktop operating system executing in a virtualized or non-virtualized environment, using any programming language suitable for software development, including, but not limited to, different versions of Microsoft Windows™ Apple™ Mac™, iOS™, Unix™/X-Windows™, Linux™, etc. The system could be implemented using a web application framework, such as Ruby on Rails.

The processing system can be in communication with a computerized data storage system. The data storage system can include a non-relational or relational data store, such as a MySQL™ or other relational database. Other physical and logical database types could be used. The data store may be a database server, such as Microsoft SQL Server™, Oracle™ IBM DB2™, SQLITE™, or any other database software, relational or otherwise. The data store may store the information identifying syntactical tags and any information required to operate on syntactical tags. In some embodiments, the processing system may use object-oriented programming and may store data in objects. In these embodiments, the processing system may use an object-relational mapper (ORM) to store the data objects in a relational database. The systems and methods described herein can be implemented using any number of physical data models. In one example embodiment, an RDBMS can be used. In those embodiments, tables in the RDBMS can include columns that represent coordinates. In the case of economic systems, data representing companies, products, etc. can be stored in tables in the RDBMS. The tables can have pre-defined relationships between them. The tables can also have adjuncts associated with the coordinates.

Suitable processors for the execution of a program of instructions include, but are not limited to, general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

The processor may also include, or be operatively coupled to communicate with, one or more data storage devices for storing data. Such data storage devices can include, as non-limiting examples, magnetic disks (including internal hard disks and removable disks), magneto-optical disks, optical disks, read-only memory, random access memory, and/or flash storage. Storage devices suitable for tangibly embodying computer program instructions and data can also include all forms of non-volatile memory, including, for example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The systems, modules, and methods described herein can be implemented using any combination of software or hardware elements. The systems, modules, and methods described herein can be implemented using one or more virtual machines operating alone or in combination with each other. Any applicable virtualization solution can be used for encapsulating a physical computing machine platform into a virtual machine that is executed under the control of virtualization software running on a hardware computing platform or host. The virtual machine can have both virtual system hardware and guest operating system software.

The systems and methods described herein can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks that form the Internet.

One or more embodiments of the invention may be practiced with other computer system configurations, including hand-held devices, microprocessor systems, microprocessor-based or programmable consumer electronics, minicomputers, mainframe computers, etc. The invention may also be practiced in distributed computing environments where tasks are performed by remote processing devices that are linked through a network.

While one or more embodiments of the invention have been described, various alterations, additions, permutations and equivalents thereof are included within the scope of the invention.

In the description of embodiments, reference is made to the accompanying drawings that form a part hereof, which show by way of illustration specific embodiments of the claimed subject matter. It is to be understood that other embodiments may be used and that changes or alterations, such as structural changes, may be made. Such embodiments, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other embodiments using alternative orderings of the computations could be readily implemented. In addition to being reordered, the computations could also be decomposed into sub-computations with the same results.

What is claimed is:

1. A computing device for automatically providing purchases financed by reverse factoring on a mobile device between at least one buyer, and at least one supplier that provides goods/services to said buyer outside of said system, each of which accesses said computing device system through a computer network interface, said computing device comprising a storage system and further comprising:
a. an analyzing module operable to analyze a plurality of payment parameters received from said buyer, wherein said payment parameters comprising at least one payment price value and at least one payment maturity date value, and operable to analyze a plurality of invoice parameters received from said supplier, wherein said invoice parameters comprising at least one invoice price value and at least one invoice maturity date value;
b. a loading module operable to load said payment parameters and said invoice parameters into an array, wherein said each value of said predefined payment parameters is an element of said array;
c. a ranking module operable to define a credit risk value based on analysis of a plurality of predefined credit risk parameters corresponding to said buyer and assign a credit risk value based on analysis of a plurality of predefined credit risk parameters to said buyer;
d. a processing module operable to locate said payment parameters to determine credit risk value corresponding to said buyer, and retrieve said credit risk value from said array according to said predefined credit risk parameters corresponding to said payment parameters and said invoice parameters, and operable apply discount factor value corresponding to said retrieved credit risk value;
e. an outputting module operable to output said retrieved credit risk value and said discount factor value into said storage system;
f. a displaying module operable to present to said buyer and said supplier said retrieved credit risk value from said storage system according to said predefined credit risk parameters corresponding to said payment parameters and said invoice parameters and said discount factor value on a display screen;
g. at least one processor that executes said analyzing module, said loading module, said ranking module, said processing module, said outputting module, and said displaying module.

2. The computing device of claim 1, wherein said ranking module defines said credit risk value based on analysis of a plurality of predefined credit risk parameters corresponding to said buyer and assign a credit risk value based on analysis of a plurality of predefined credit risk parameters to said buyer in said array.

3. The computing device of claim 1, wherein said plurality of predefined credit risk parameters comprises transactional and financial data of said buyer.

4. The computing device of claim 1, wherein said invoice parameters comprises data retrieved from at least one invoice.

5. The computing device of claim 1 further comprising an intermediary module for the reverse factoring transacting system corresponding to said retrieved credit risk value from said storage system according to said predefined credit risk parameters corresponding to said payment parameters and said invoice parameters and said discount factor value comprising a plurality of predefined schemes for a payment period.

6. The computing device of claim 1 further comprising a payment module for arrangement of capital transfer between said buyer and/or said and/or said supplier corresponding to said generated reverse factoring transacting system.

7. A computer-implemented method being executed by a processor of a computing device for automatically providing purchases financed by reverse factoring on a mobile device between at least one buyer, and at least one supplier that provides goods/services to said buyer outside of said system, each of which accesses said computing device system through a computer network interface, said method comprising:
a. analyzing a plurality of payment parameters received from said buyer, wherein said payment parameters comprising at least one payment price value and at least one payment maturity date value, and analyzing a plurality of invoice parameters received from said supplier, said invoice parameters comprising at least one invoice price value and at least one invoice maturity date value;
b. loading said payment parameters and said invoice parameters into an array, wherein said each value of said predefined payment parameters is an element of said array;
c. defining a credit risk value based on analysis of a plurality of predefined credit risk parameters corresponding to said buyer and assigning a credit risk value based on analysis of a plurality of predefined credit risk parameters to said buyer;
d. locating said payment parameters to determine credit risk value corresponding to said buyer, and retrieving said credit risk value from said array according to said predefined credit risk parameters corresponding to said payment parameters and said invoice parameters, and applying a discount factor value corresponding to said retrieved credit risk value;
e. outputting said retrieved credit risk value and said discount factor value into said storage system; and
f. presenting to said buyer and said supplier said retrieved credit risk value from said storage system according to said predefined credit risk parameters corresponding to said payment parameters and said invoice parameters and said discount factor value on a display screen.

8. The method of claim 7, wherein said step of defining said credit risk value based on analysis of a plurality of predefined credit risk parameters corresponding to said buyer and assign a credit risk value based on analysis of a plurality of predefined credit risk parameters to said buyer is performed in said array.

9. The method of claim 7, wherein said plurality of predefined credit risk parameters comprises transactional and financial data of said buyer.

10. The method of claim 7, wherein said invoice parameters comprises data retrieved from at least one invoice.

11. The method of claim 7 further comprising a step of generating reverse factoring transacting system corresponding to said retrieved credit risk value from said storage system according to said predefined credit risk parameters corresponding to said payment parameters and said invoice parameters and said discount factor value comprising a plurality of predefined schemes for a payment period.

12. The method of claim 7 further comprising a step of arranging capital transfer between said buyer and/or said and/or said supplier corresponding to said generated reverse factoring transacting system.

13. A non-transitory computer-readable medium having stored thereon instructions that, when executed by a computerized device, cause said computerized device to execute a computer-implemented method comprising:
a. analyzing a plurality of payment parameters received from said buyer, wherein said payment parameters comprising at least one payment price value and at least one payment maturity date value, and analyzing a plurality of invoice parameters received from said supplier, said invoice parameters comprising at least one invoice price value and at least one invoice maturity date value;
b. loading said payment parameters and said invoice parameters into an array, wherein said each value of said predefined payment parameters is an element of said array;
c. defining a credit risk value based on analysis of a plurality of predefined credit risk parameters corresponding to said buyer and assigning a credit risk value based on analysis of a plurality of predefined credit risk parameters to said buyer;
d. locating said payment parameters to determine credit risk value corresponding to said buyer, and retrieving said credit risk value from said array according to said predefined credit risk parameters corresponding to said payment parameters and said invoice parameters, and applying a discount factor value corresponding to said retrieved credit risk value;
e. outputting said retrieved credit risk value and said discount factor value into said storage system; and
f. presenting to said buyer and said supplier said retrieved credit risk value from said storage system according to said predefined credit risk parameters corresponding to said payment parameters and said invoice parameters and said discount factor value on a display screen.

14. The non-transitory computer-readable medium of claim 13, wherein said step of defining said credit risk value based on analysis of a plurality of predefined credit risk parameters corresponding to said buyer and assign a credit risk value based on analysis of a plurality of predefined credit risk parameters to said buyer is performed in said array.

15. The non-transitory computer-readable medium of claim 13, wherein said plurality of predefined credit risk parameters comprises transactional and financial data of said buyer.

16. The non-transitory computer-readable medium of claim 13, wherein said invoice parameters comprises data retrieved from at least one invoice.

17. The non-transitory computer-readable medium of claim 13 cause said computerized device to execute a computer-implemented method further comprising a step of generating reverse factoring transacting system corresponding to said retrieved credit risk value from said storage system according to said predefined credit risk parameters corresponding to said payment parameters and said invoice parameters and said discount factor value comprising a plurality of predefined schemes for a payment period.

18. The non-transitory computer-readable medium of claim 13 cause said computerized device to execute a computer-implemented method further comprising a step of arranging capital transfer between said buyer and/or said and/or said supplier corresponding to said generated reverse factoring transacting system.
